(19) United States
(12) Patent Application Publication
(10) Pub. No.: US 2006/0249247 A1
(43) Pub. Date: Nov. 9, 2006

(54) Method and apparatus for the high speed application of hook and loop fasteners

(76) Inventor: Robert J. DeGrand, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/375,956

(22) Filed: Mar. 15, 2006

Related U.S. Application Data
(60) Provisional application No. 60/677,724, filed on May 4, 2005.

(51) Int. Cl. B32B 37/00; B32B 38/00; B32B 41/00

(52) U.S. Cl. 156/249; 156/64; 156/226; 156/541; 156/542; 156/361; 156/362; 156/363; 156/443

(57) ABSTRACT

An applicator and method for applying hook and loop fasteners to a product. The apparatus comprises a web assembly having a storage member that stores a web containing a plurality of hook and loop fasteners. The web assembly further has a distribution assembly that reciprocatably distributes portions of the web from the storage member. A transfer assembly receives the web from the distribution assembly and transfers the web to an applicator. A control assembly communicates the position of the product to the applicator and directs the applicator to drive the portion of the web through the applicator. At a high speed rate, the applicator removes the hook and loop fasteners from the portion of the web and deposits the hook and loop fasteners on predetermined areas of the product.

### CROSS REFERENCE TO RELATED APPLICATIONS

This application claims priority to U.S. provisional application having Ser. No. 60/677,724 filed May 4, 2005, the provisional application being incorporated herein.

### STATEMENT REGARDING FEDERALLY SPONSORED RESEARCH OR DEVELOPMENT

N/A

### BACKGROUND OF THE DISCLOSURE

The present disclosure relates to a fastener applicator. In particular, the present disclosure relates to an applicator which applies hook and loop fasteners at a high speed rate to products, packages or cartons. While the disclosure is described in particular with respect to the application of hook and loop fasteners to cartons, those skilled in the art will recognize the wider applicability of the inventive principles disclosed hereinafter.

Current packaging systems require separate machines to process carton blanks into assembled packages. In processing the carton blanks, a conveyor transfers each carton blank to a label applicator that applies a label (i.e., instruction labels, shipping labels) to the carton blank as the blanks advance through the label applicator. The labels can be transferred from the label applicator to the blanks by stamping processes, air pressure processes and sealing processes or a combination of these processes.

Labels can be efficiently applied to the cartons by current label applicators since the labels have thin and uniform configurations. Some cartons, however, require fasteners such as hook and loop fasteners that have a material composition of a cloth nature. As such, hook and loop fasteners require a separate application process than current label applicators due to their material composition. Due to the configuration and composition of the hook and loop fasteners, these hook and loop fasteners are hand applied to the respective cartons. Accordingly, these hook and loop fasteners require time-consuming processes as a result of the configuration and composition of hook and loop fasteners.

I have determined that a low cost applicator construction can be obtained that can apply hook and loop fasteners to products with high efficiency, speed and accuracy.

### SUMMARY OF THE DISCLOSURE

The present disclosure relates to an apparatus which applies hook and loop fasteners to a product. The apparatus comprises a web assembly having a storage member that stores a web containing a plurality of hook and loop fasteners. The web assembly further has a distribution assembly that reciprocatably distributes portions of the web from the storage member. A transfer assembly receives the web from the distribution assembly and transfers the web to an applicator.

A control assembly communicates the position of the product to the applicator and directs the applicator to drive the portion of the web through the applicator. At a high speed rate, the applicator removes the hook and loop fasteners from the portion of the web and deposits the hook and loop fasteners on predetermined areas of the product.

### BRIEF DESCRIPTION OF THE DRAWINGS

The objects of the disclosure are achieved as set forth in the illustrative embodiments shown in the drawings, which form a part of this specification.

FIG. 1 is a side elevational view of a web assembly, applicator, conveyor assembly and control assembly constructed in accordance with and embodying the present disclosure;

FIG. 2 is an elevational view of the web assembly having a storage member constructed in accordance with and embodying the present disclosure;

FIG. 3 is a perspective view of a web of the web assembly of FIG. 1 containing a plurality of hook and loop fasteners;

FIG. 4 is a side elevational view of the web assembly of FIG. 2;

FIG. 5 is a side elevational view of an applicator illustrating a stepper motor, a control panel and a rewind assembly constructed in accordance with and embodying the present disclosure; and

FIG. 6 is a flowchart of operating steps of the present disclosure.

Corresponding reference characters indicate corresponding parts throughout the several views of the drawings.

### DETAILED DESCRIPTION OF THE DISCLOSURE

The following detailed description illustrates the disclosure by way of example and not by way of limitation. This description will clearly enable one skilled in the art to make and use the disclosure, and describes several embodiments, adaptations, variations, alternatives and uses of the disclosure including what I presently believe is the best mode of carrying out the disclosure. As various changes could be made in the constructions discussed herein without departing from the scope of the disclosure, it is intended that all matter contained in the description are shown in the accompanying drawings shall be interpreted as illustrative and not in a limited sense.

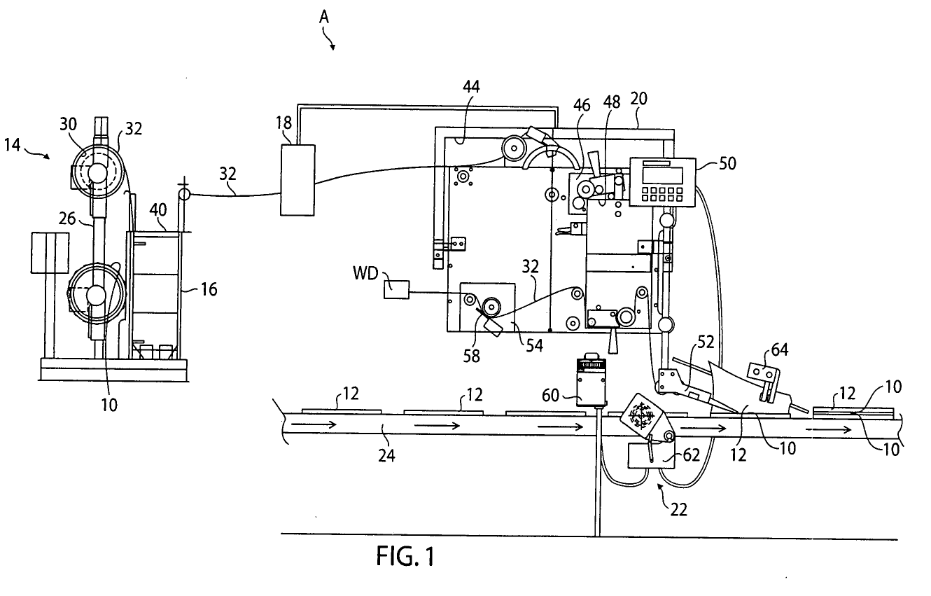

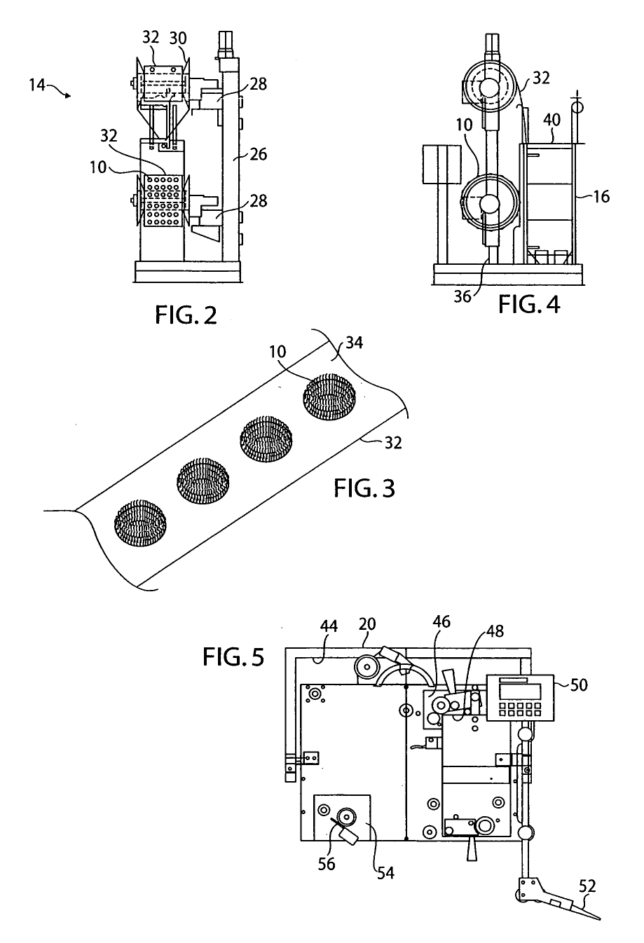

The present system A applies fasteners 10 at a high speed rate to products 12 (FIG. 1). System A comprises a web assembly 14, a distribution assembly 16, a transfer assembly 18, an applicator 20, a control assembly 22 and a conveyor assembly 24. Referring to FIG. 2, the web assembly 14 includes a rack system 26. The rack system 26 further includes support members 28 and a movable track (not shown). Each support member 28 holds a storage member 30 as shown. The lower support member 28 holds a spare or un-used storage member 30 while the upper support member 28 holds an in-use storage member 30.

When one of the storage members 30 is initially installed on the lower support member 28, the track moves the lower support member 28 to an upper position so that the now upper support member 28 and associated storage member 30 may be accessed by system A. Additionally, the track moves the upper support member 28 to the lower position in order to discharge a used storage member 30 and to receive a new un-used storage member 30.

Each storage member 30 stores a web 32 containing a plurality of fasteners 10 such as hook and loop fasteners (i.e., those sold under the brand name Velcro®). The hook and loop fasteners 10 have a typical height of less than ½ inch. Accordingly, these hook and loop fasteners 10 are thicker than any labels (i.e., instruction labels, shipping labels) typically applied to products. Additionally, these hook and loop fasteners typically comprise a cloth material. As shown in FIG. 3, the web 32 utilizes a release adhesive 34 to hold the hook and loop fasteners 10 on the web 32. In an embodiment, the web 32 may have a minimum width up to an including one inch and a maximum width up to and including 4 inches. Regardless of the width of the web 32, the web 16 wraps the hook and loop fasteners 10 around the storage member 30.

Returning to FIG. 2, the storage member 30 may comprise a spool to store the large amount of hook and loop fasteners 10 on the web 32. In this embodiment, the storage member 30 may hold up to and including 49,000 hook and loop fasteners 10. In another embodiment, the storage member 30 may include a roller which may hold up to and including 8,000 hook and loop fasteners 10. A base 36 of the rack system 26 elevates the bottom storage member 30 to facilitate installation and removal of the storage member 30.

The distribution assembly 16 is positioned adjacent to the storage member 30 (FIG. 4). The distribution assembly 16 operatively connects with the web assembly 14. The distribution assembly 16 has a discharge member 40 that connects with a portion of the web 32. The discharge member 40 is configured to reciprocatably distribute the portions of the web 32 from the storage member 30 in a pattern that eliminates any entanglement of the web 32 as the web 32 leaves the storage member 30. As will be discussed, the system A of the present disclosure applies the hook and loop fasteners 10 at a high speed rate. As such, the discharge member 40 reciprocates the portions of the web 32 back and forth between ends of the storage member 30 and across the discharge member 40. By reciprocating the web 32 as the web 32 leaves the storage member 30, the web 32 does not tangle upon itself.

The applicator 20 (FIG. 5) is configured to receive the web 32 from the storage member 30. The applicator 20 has a body 44 that positions an automatic speed follower 46, a loop box 48, a controller 50 and a wipe-on applicator 52. The wipe-on applicator 52 may be configured for right hand or left hand operations. The applicator 20 further comprises a rewind assembly 54 having a stepper motor 56 that drives or pulls the web 32 through the wipe-on applicator 52 at a high speed rate. The wipe-on applicator 52 is configured to accommodate the configuration and composition of the at least one hook and loop fastener 10 in order to remove at least one hook and loop fastener 10 from the portion of the web 32 and deposits the at least one hook and loop fastener 10 onto one of the products 12. The controller 50 is configured to accommodate the configuration and composition of the at least one hook and loop fastener 10 in order to control and count each hook and loop fastener 10.

Returning to FIG. 1, a schematic layout in a side elevational view of the system A is shown. As illustrated, a transfer assembly 58 transfers the portion of the web 32 from the web assembly 14 to the applicator 20. The transfer assembly 58 receives the web 32 from the discharge member 40 and transfers the web 32 to the applicator 20. Since the web 32 may exit the web assembly 14 perpendicular to the applicator 20, the transfer assembly 58 may transfer the web 32 at a desired angle to the applicator 20. In one embodiment, the transfer assembly 18 comprises a mandrel that suspends from the applicator 20 at a position between the distribution assembly 16 and the applicator 20. Furthermore, the transfer assembly 58 may be positioned offset between the discharge member 40 and the applicator 20 to maintain tension of the portion of the web 32 entering the applicator 20.

The control assembly 22 operatively connects with the applicator 20. Additionally, the control assembly 22 operatively connects with the conveyor assembly 24 in order to monitor the speeds of the belt of the conveyor assembly 24. The control assembly 22 includes a sensor 60 and an encoder 62. The sensor 60 is located near the conveyor assembly 24, wherein the conveyor assembly 24 conveys the products 52 across or near the sensor 60. The sensor 60 communicates to the encoder 62 the position of each product 52 as the product 52 moves toward the wipe-on applicator 52. The encoder 62 operatively connects to the conveyor assembly 24 and operatively connects to the controller 50 such that the controller 50 commands or directs stepper motor 56 to control movement of the portion of the web 32 in tandem with the conveyor assembly 24. The encoder 62 directs the stepper motor 56, via the controller 50, to pull the portion of the web 32 through the wipe-on applicator 52 at the high speed rate such that the wipe-on applicator 52 receives and deposits the at least one hook and loop fastener 10 at a predetermined position on the product 12. As such, the encoder 62 coordinates application of the hook and loop fasteners 10 as the conveyor assembly 24 moves the product 12 past the applicator 20.

The system A further comprises a fold assembly 64, which folds the products 12 in a particular configuration and positions the products 12 on the conveyor assembly 24. In an embodiment, the fold assembly 64 may position the products 12 on the conveyor assembly 24 such that each product 12 aligns with the wipe-on applicator 52 in a position before the wipe-on applicator 52 deposits the hook and loop fasteners 10 onto the products 12. In another embodiment, the fold assembly 64 may fold the products in the configuration after the wipe-on applicator 52 has deposited the respective hook and loop fasteners 10. The folder assembly 54 may include a gluer to assist in forming the configuration of the products 12.

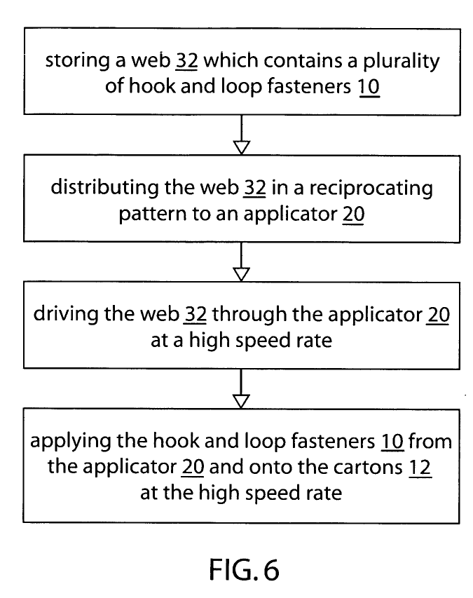

Turning to FIG. 6 and referring to FIGS. 1-5, the present disclosure relates to a method of high speed application of hook and loop fasteners 10. During use, the operator loads a storage member 30 that contains a full web 32 of hook and loop fasteners 10 onto the lower support member 28. The operator then activates the track of the rack system 26 to move the loaded support member 28 and storage member 30 to the upper position and to expose another support member 28 for additional loading of another storage member 30.

Once the storage member 30 is properly positioned, the user then feeds a front portion of the web 32 through the distribution assembly 16, across the transfer assembly 58 and into the applicator 20. The front of the web 32 passes through the applicator 20 and connects with the rewind assembly 54. The stepper motor 56 of the rewind assembly 54 activates to drive or pull the web 32 through the applicator 20. When stepper motor 56 activates, the storage member 30 distributes the web 32 to the applicator 20 via the distribution assembly 16 and the transfer assembly 58.

While feeding the web 32 to the transfer assembly 58, the distribution assembly 16 distributes the web 32 in a reciprocating pattern across the discharge member 40.

By distributing the web 32 in a reciprocating pattern, the portion of web 32 does not become entangled while exiting the storage member 30. Since the web 32 remains tangle free, the stepper motor 56 can drive the web 32 through the applicator 20 at the high speed rate. In an embodiment, the stepper motor 56 may drive the portion of web 32 through the applicator 20 at the high speed rate of 5000 inches per minute. As such, the stepper motor 56 may drive the web 32 approximately 416 feet per minute.

Upon leaving the web assembly 14, transfer assembly 58 receives the web 32 and angles the web 32 toward the applicator 20. The applicator 20, in turn, transfers the web 32 through the speed follower 46, loop box 48 and controller 50. The controller 50 monitors data of the moving web 32 such as the count and speed of the hook and loop fasteners 10 prior to the hook and loop fasteners 10 entering the wipe-on applicator 52.

The wipe-on applicator 52 is sized and shaped to remove at least one of the hook and loop fasteners 10 from the portion of the web 32 and to deposit the at least on hook and loop fastener 10 onto the predetermined position of the respective products 12. The backside of each removed hook and loop fastener 10 contains a seal which adheres to the hook and loop fastener 10 to the product 12. After the wipe-on applicator 52 deposits the hook and loop fastener 10, the rewind assembly 54 collects the fastener free portion of the web 32 for waste disposal WD.

While the stepper motor 56 drives the web 32 through the wipe-on applicator 52, the conveyor assembly 24 conveys the products 12 to the wipe-on applicator 52. The sensor 60 measures the position of each product 12 on the conveyor assembly 24 and communicates the position of the products 12 to the encoder 62. The encoder 62, which is operatively connected to the stepper motor 56, communicates with the controller 50 which commands or directs the stepper motor 56 to drive the web 32 through the wipe-on applicator 52 at the high speed rate while the wipe on applicator 36 properly deposits the hook and loop fasteners 10 on the predetermined positions of each product 12. In an embodiment, the encoder 62 may also communicate with the controller 50 to direct the conveyor assembly 24 to adjust the speed of the conveyor belt to properly coordinate positioning of the products 12 toward the wipe-on applicator 52 in tandem with the web 32 driven by the stepper motor 56.

During operation, the fold assembly 54 may fold the products 12 in a predetermined configuration and place the products 12 on the conveyor assembly 24 before the wipe-on applicator 52 applies the hook and loop fasteners 10. In another embodiment, the fold assembly 54 may fold the products 12 after the wipe-on applicator 52 has applied the hook and loop fasteners 10. The fold assembly 54 may glue flats of the products 12 during the folding operation. In one embodiment, the product 12 comprises carton blanks. During operation, the conveyor assembly 24 moves the carton blank 12 through the wipe-on applicator 52 in one direction. After the carton blank 52 receives the deposited hook and loop fastener 10 on the predetermined area, the conveyor assembly 24 moves the carton blank 12 back through the wipe-on applicator 52 so that the carton blank 12 receives another hook and loop fastener 10 positioned on another predetermined area. The fold assembly 54 then folds the carton blank 12 to mate the deposited hook and loop fasteners 10.

In view of the above, it will be seen that the several objects of the disclosure are achieved and other advantageous results are obtained. As various changes could be made in the above constructions without departing from the scope of the disclosure, it is intended that all matter contained in the above description or shown in the accompanying drawings shall be interpreted as illustrative and not in a limiting sense.

Having thus described the disclosure, what is claimed and desired to be secured by Letters Patent is:

1. An apparatus for applying hook and loop fasteners to products, comprising:
a web assembly having a storage member that stores a web containing a plurality of hook and loop fasteners,
a distribution assembly that is operatively connected with the web assembly, the distribution assembly having a discharge member that connects with a portion of the web, the discharge member being configured to reciprocatably distribute the portion of the web from the storage member;
an applicator that is configured to receive the distributed portion of the web from the distribution assembly, the applicator having a stepper motor and a wipe-on applicator, the stepper motor being configured to pull the portion of the web through the wipe-on applicator at a high speed rate and the applicator being configured to remove at least one hook and loop fastener from the portion of the web and deposit the at least one hook and loop fastener onto one of the products; and
a control assembly that is operatively connected to the applicator, the control assembly having a sensor and an encoder wherein the sensor communicates to the encoder the position of each product as the product moves toward the wipe-on applicator such that the encoder, which is operatively connected with the stepper motor, directs the stepper motor to pull the portion of the web through the wipe-on applicator at the high speed rate such that the wipe-on applicator deposits the at least one hook and loop fastener at a predetermined position on the product.

2. The apparatus of claim 1 wherein the web contains up to and including 49,000 hook and loop fasteners.

3. The apparatus of claim 2 wherein the storage member is a spool that is configured to hold the web.

4. The apparatus of claim 2 wherein the web has a minimum width of one inch and a maximum width of four inches.

5. The apparatus of claim 1 wherein the stepper motor drives the web at the high speed rate of 5000 inches per minute.

6. The apparatus of claim 1 wherein the product is a carton blank.

7. The apparatus of claim 6 further comprising a conveyor assembly that moves the carton blank toward the applicator wherein the conveyor assembly is operatively connected to the encoder.

8. The apparatus of claim 7 wherein the encoder controls the movement of the stepper motor in tandem with the conveyor assembly.

9. The apparatus of claim 8 further comprising a fold assembly which folds each carton blank in a configuration and positions the carton blank on the conveyor assembly such that carton blank aligns with the wipe-on applicator in a position before the wipe-on applicator has deposited the at least one hook and loop fastener.

10. The apparatus of claim 8 further comprising a fold assembly which folds the carton blank in a configuration after the wipe-on applicator has deposited the at least one hook and loop fastener.

11. An apparatus for applying hook and loop fasteners to carton blanks that are being conveyed by a conveyor assembly, comprising:
a web assembly having a storage member that stores a web containing up to and including 49,000 hook and loop fasteners,
a distribution assembly that is operatively connected with the web assembly, the distribution assembly having a discharge member that connects with a portion of the web, the discharge member being configured to reciprocatably distribute the portion of the web from the storage member;
a transfer assembly that is configured to receive the portion of the web from the discharge member and to transfer the portion of the web at a desired angle;
an applicator that is configured to receive the angled portion of the web from the transfer assembly, the applicator having a stepper motor and a wipe-on applicator, the stepper motor being configured to pull the portion of the web through the wipe-on applicator at a high speed rate up to and including 5000 inches per minute and the wipe-on applicator being configured to remove at least one hook and loop fastener from the portion of the web and deposit the at least one hook and loop fastener onto one of the carton blanks; and
a control assembly that is operatively connected to the applicator, the control assembly having a sensor and an encoder wherein the sensor communicates to the encoder the position of each carton blank as the carton blank moves toward the wipe-on applicator such that the encoder, which is operatively connected with the stepper motor, directs the stepper motor to pull the portion of the web through the wipe-on applicator at the high speed rate such that the wipe-on applicator deposits the at least one hook and loop fastener at a predetermined position on the carton blank.

12. The apparatus of claim 11 wherein the conveyor assembly is operatively connected to the encoder and the encoder controls the movement of the steeper motor in tandem with the conveyor assembly.

13. A method of high speed application of hook and loop fasteners to products, comprising:
storing a web which contains a plurality of hook and loop fasteners;
distributing a portion of the web in a reciprocating pattern to an applicator;
driving the portion of the web though the applicator at a high speed rate;
moving the products toward the applicator; and
removing at least one hook and loop fastener from the portion of the web and depositing the at least one hook and loop fastener on one of the products at the high speed rate.

14. The method of applying hook and loop fasteners of claim 13 further comprising transferring the web at an angle to the applicator.

15. The method of applying hook and loop fasteners of claim 13 further comprising sensing the position of the products as the products move toward the applicator.

16. The method of applying hook and loop fasteners of claim 15 further comprising controlling the drive of the web through the applicator based on the sensed position of the products.

17. The method of applying hook and loop fasteners of claim 13 wherein driving the portion of the web through the applicator at the high speed rate comprises driving the portion of the web at the rate of 5000 inches per minute through the applicator.

18. The method of applying hook and loop fasteners of claim 13 wherein the stored web contains up to and including 49,000 hook and loop fasteners.

19. The method of applying hook and loop fasteners of claim 13 further comprising folding the products in a configuration after the applicator deposits the at least one hook and loop fastener.

20. The method of applying hook and loop fasteners of claim 19 wherein folding the products comprises gluing flats of the products.
